(19) United States
(12) Patent Application Publication
(10) Pub. No.: US 2019/0145156 A1
(43) Pub. Date: May 16, 2019

(54) Bracing Member, Coupling and System for a Sectional Door

(71) Applicant: Centurion Garage Doors Pty Ltd, Wangara, Western Australia (AU)

(72) Inventors: Steven Ronald Canning, Dianella, Western Australia (AU); Christopher Neil Canning, Ballajura, Western Australia (AU); Peter Francis William, Tuart Hill, Western Australia (AU)

(21) Appl. No.: 16/302,160

(22) PCT Filed: May 30, 2017
(86) PCT No.: PCT/AU2017/050510

§ 371 Date: Nov. 16, 2018

(30) Foreign Application Priority Data
Jun. 1, 2016 (AU) 2016902099

(51) Int. Cl. E06B 3/48; E05D 15/16

(52) U.S. Cl. CPC E06B 3/485; E05D 15/165

(57) ABSTRACT

A bracing member for a door guide track (28A), the door guide track being adapted to receive a roller member (38) for a garage door roller assembly (30A), which includes a shaft (40) around which panels (27A) of a garage door are wound. The bracing member comprises a body in the form of a sleeve (10A) that defines an interior space into which a section of the door guide track is retained. The bracing member has a longitudinal opening (22) so that does not interfere with normal operation of the roller assembly. The sleeve has return sections that engage an abutment member (42) of the roller assembly and stop the bracing member from spreading when under load, for example under windy conditions. The bracing member can be affixed to a solid structure such as a garage wall and includes strengthening ribs on its exterior.

### FIELD OF THE INVENTION

The present invention relates to a bracing member for a sectional door such as a guide track mounted sectional door. The present invention also relates to a coupling for mounting a sectional door panel to a door guide track and to a sectional door system.

### BACKGROUND OF THE INVENTION

Sectional doors are required to meet various engineering requirements including wind loads when in a closed position to ensure the door is able to withstand pressure forces acting on the door both inwardly and outwardly due to ambient winds. Failure of a sectional door in high winds can result in the door becoming loose or completely free from its mounting frame causing damage to people and/or property.

One way of strengthening sectional doors is to manufacture the doors from stronger or thicker material. Another way involves reinforcing the doors with rigid struts, beams or bars.

However, these types of modifications increase manufacturing costs and result in doors that are substantially heavier which can hamper storage, transportation, installation and operation of the doors. For example, the heavier a door the more powerful a motor is required to operate the door.

Accordingly, there is a need to provide an improved bracing and reinforcement solutions that address or at least partially alleviates the problems with existing sectional doors.

### SUMMARY OF THE INVENTION

The present invention also provides a bracing member for a door guide track, wherein the door guide track has a body comprising a web and two opposed longitudinal sides extending therefrom to define an interior channel adapted to receive a roller member of a roller assembly that also includes a shaft member and an abutment member, the roller assembly being adapted to mount a sectional door panel to the door guide track, the bracing member comprising: a sleeve member that defines an interior space and an inner surface and is adapted to be fitted over at least a section of the door guide track, wherein the sleeve member comprises a web and two opposed longitudinal side walls joined by the web and each of the opposed longitudinal side walls comprise a first return section and a second return section adapted to engage with the abutment member.

A second aspect of the present invention provides a bracing member for a door guide track, wherein the door guide track has a body comprising a web and two opposed longitudinal sides extending therefrom to define an interior channel adapted to receive a roller member of a roller assembly that also includes a shaft member and wherein the roller assembly is adapted to mount a sectional door panel to the door guide track, the bracing member comprising:
(i) a sleeve member that defines an interior space and an inner surface and is adapted to be fitted over at least a section of the door guide track and the roller member to reinforce the mount of the sectional door panel to the door guide track without interfering with the normal path of the roller assembly along the door guide track.

In a third aspect of the invention, there is provided a bracing member for a door guide track, wherein the door guide track has a body comprising a web and two opposed longitudinal sides extending therefrom to define an interior channel adapted to receive a roller member of a roller assembly that also includes a shaft member and an abutment member, the roller assembly being adapted to mount a sectional door panel to the door guide track, the bracing member comprising: a sleeve member that defines an interior space and an inner surface and is adapted to be fitted over at least a section of the door guide track and the roller member to reinforce the mount of the sectional door panel to the door guide track without interfering with the normal path of the roller assembly along the door guide track, wherein the interior space includes a first part adapted to retain, capture and/or abut said section of the door guide track and the roller assembly and a second part adapted to retain, capture and/or abut an abutment member.

The present invention also provides a coupling for mounting a sectional door panel to a door guide track, the coupling comprising:
(i) a bracing member according to a first, second or third aspect of the present invention; and
(ii) a roller assembly including a shaft member and a roller member.

The present invention also provides a sectional door system comprising a sectional door, a door guide track and at least one of a bracing member or a coupling as described herein.

### BRIEF DESCRIPTION OF THE DRAWINGS

FIG. 1A is an isometric view of a bracing member for a door guide track according to one embodiment of the first aspect of the present invention;

FIG. 1B is an end view of the bracing member in FIG. 1A;

FIG. 2 is a rear view of a sectional door according to one embodiment of the third aspect of the present invention;

FIG. 3A is a detailed view of the top corner of the sectional door in FIG. 2;

FIG. 3B is a view from above of the top left corner of the sectional door in FIG. 2;

FIG. 4A is an isometric view of a bracing member for a door guide track according to another embodiment of the first aspect of the present invention;

FIG. 4B is an end view of the bracing member in FIG. 4A; and

FIG. 5 depicts the bracing member in FIGS. 4A and 4B shown in the same view and arrangement as the other embodiment of the bracing member depicted in FIG. 3B.

### DETAILED DESCRIPTION OF THE INVENTION

According to a first aspect, the present invention provides a bracing member for a door guide track, wherein the door guide track has a body comprising a web and two opposed longitudinal sides extending therefrom to define an interior channel adapted to receive a roller member of a roller assembly that also includes a shaft member and an abutment member, the roller assembly being adapted to mount a sectional door panel to the door guide track, and the bracing member comprising a sleeve member that defines an interior space and an inner surface and is adapted to be fitted over at least a section of the door guide track and the roller member to reinforce the mount of the sectional door panel to the door guide track, wherein the sleeve member comprises a web and two opposed longitudinal side walls joined by the web and each of the two opposed longitudinal side walls comprise a first return section and a second return section adapted to engage with the abutment member.

Preferably, the first return section, or first wall, runs perpendicular to the main plane of the said longitudinal side wall.

Preferably, the second return section, or second wall, runs parallel to the main plane of the said longitudinal side wall.

The first and second return sections or walls may define a rebate or channel to frictionally engage the abutment member.

For the purposes of the present invention the term “reinforce” when used herein with respect to a mount means to strengthen said mount such that it requires greater force to disrupt or destroy said mount and separate the mounted components.

Preferably, the bracing member is adapted to be fixed relative to the door guide track.

Preferably, the interior space includes a first part adapted to retain, capture and/or abut said section of the door guide track and the roller assembly.

Preferably, the interior space defines an axial passage or pathway along the length of the sleeve member.

Preferably, the interior space includes a second part adapted to retain, capture and/or abut the abutment member.

Preferably, the second part of the interior space comprises a contact surface for the abutment member and is adapted to contact the abutment member when the roller assembly or part thereof is deflected or moved due to forces applied to the door.

Preferably, the sleeve member comprises a longitudinal opening located opposite the web and being adapted to receive and allow the passage of the shaft member therethrough, when in use. Preferably, the longitudinal opening extends the entire length of the sleeve member.

The sleeve member may have a generally “U” or “C” shaped outer cross section.

Preferably, the inner surface comprises a profile that is shaped to fit around at least part of the outer profile of the door track guide body. Preferably, the inner surface profile is shaped to fit around the outer profile of part of the web of the door track guide body. Even more preferably the inner surface profile is shaped to fit around part of the outer profile of the two opposed longitudinal sides of the door track guide body.

Preferably, the fit between the inner surface of the sleeve member and the door track guide body is a flush fit, interference fit or a friction fit. Even more preferably, the sleeve member is adapted to slidingly fit on the door track guide body.

Preferably, the sleeve member further comprises a reinforcement member adapted to prevent, control or otherwise limit the deflection of the sleeve member. Preferably, the reinforcement member comprises at least one lateral rib on the outer surface of the sleeve member. Preferably, the reinforcement member extends around the entire outer surface of the sleeve member.

Preferably, the reinforcement member is located towards the middle section of the sleeve member.

Preferably, the bracing member is adapted to be anchored to a structure adjacent to the door guide track such as wall or other fixed object or structure. In this regard, the sleeve member may further comprise an anchor point for a fixing. Preferably, the anchor point is located in the web of the sleeve member. Preferably, the anchor point is an aperture.

Preferably, the fixing is a bolt, screw of some other threaded fixing member adapted to be fixed to the structure adjacent to the door guide track.

By fitting over at least a section of the door guide track, the sleeve member acts to reinforce the mount of the sectional door panel to the door guide track, preferably by preventing deformation of the section of the door guide track including the roller member.

The mount may be further strengthened by employing the abutment member on the shaft member and providing a sleeve member adapted to receive or engage with the abutment member by means of the return sections. Providing the return sections on the bracing member, which are adapted to engage the abutment member of the roller assembly, the two members interlock and stop the bracing member from spreading when under load.

The present invention also provides a bracing member for a door guide track, wherein the door guide track has a body comprising a web and two opposed longitudinal sides extending therefrom to define an interior channel adapted to receive a roller member of a roller assembly that also includes a shaft member and wherein the roller assembly is adapted to mount a sectional door panel to the door guide track, the bracing member comprising:
(i) a sleeve member that defines an interior space and an inner surface and is adapted to be fitted over at least a section of the door guide track and the roller member to reinforce the mount of the sectional door panel to the door guide track without interfering with the normal path of the roller assembly along the door guide track.

The present invention may also provide a bracing member for a door guide track, wherein the door guide track has a body comprising a web and two opposed longitudinal sides extending therefrom to define an interior channel adapted to receive a roller member of a roller assembly that also includes a shaft member and an abutment member, the roller assembly being adapted to mount a sectional door panel to the door guide track, the bracing member comprising: a sleeve member that defines an interior space and an inner surface and is adapted to be fitted over at least a section of the door guide track and the roller member to reinforce the mount of the sectional door panel to the door guide track without interfering with the normal path of the roller assembly along the door guide track, wherein the interior space includes a first part adapted to retain, capture and/or abut said section of the door guide track and the roller assembly and a second part adapted to retain, capture and/or abut the abutment member.

The abutment member may be varied. Preferably, the abutment member comprises a body such as a disk or some other suitably shaped element such as a body with at least one projection or surface that is adapted to frictionally engage a compatible rebate or channel in the sleeve member. Preferably, the abutment member defines a longitudinal web with at least one projection extending therefrom. Preferably, the abutment member comprises a pair of projections that extend perpendicularly from the longitudinal web. For example, the abutment member may be a channel member and/or have a generally “C” or “U” shaped cross section.

Preferably, the abutment member is fixedly mounted on the shaft member.

The bracing member according to the first aspect of the present invention may form part of a coupling. Thus, according to a second aspect of the invention there is provided a coupling for mounting a sectional door panel to a door guide track, the coupling comprising:
(i) a bracing member according to a first aspect of the present invention; and
(ii) an abutment member assembly adapted to be mounted to the section door panel and including a shaft member and an abutment member mounted on said shaft member.

Preferably, the abutment member comprises a roller member. When the abutment member comprises a roller member it will be appreciated that the coupling functions as a roller assembly.

Alternatively, the abutment member may comprise a body such as a disk or some other suitably shaped element such as a fixed body with at least one projection or surface that is adapted to frictionally engage a compatible rebate or channel in the sleeve member. In this form of the invention it will be appreciated that the coupling functions to increase the strength of the mount between the sectional door panel and the door guide track and not as a roller assembly per se.

In another form of the invention the abutment member may comprise a roller assembly and a body such as disk or some other suitably shaped element. In this form of the invention the coupling functions as both a roller assembly and to increase the strength of the mount.

The bracing member according to the first aspect of the present invention and the coupling according to the second aspect of the present invention may form part of a sectional door system. Thus, according to a third aspect of the present invention there is provided a sectional door system comprising a sectional door, a door guide track and at least one of a bracing member or a coupling as described herein whereby forces imparted to the sectional door are transferred to said door track guide through said bracing member and or said coupling.

Preferably the sectional door comprises a plurality of panels and each panel comprises at least one bracing member or coupling that mounts the panel to the door guide track.

Preferably, each panel of the sectional door comprises a plurality of bracing members or couplings. When each panel comprises a plurality of bracing members or couplings they may be located on opposing sides of the panel to mount the panel in door guide tracks located on opposite sides of the sectional door.

Preferably, the sectional door system comprises at least one coupling comprising an abutment member comprising a roller member and at least one coupling comprising an abutment member as described herein.

General

Those skilled in the art will appreciate that the invention described herein is susceptible to variations and modifications other than those specifically described. The invention includes all such variation and modifications. The invention also includes all of the steps and features referred to or indicated in the specification, individually or collectively and any and all combinations or any two or more of the steps or features.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness. None of the cited material or the information contained in that material should, however be understood to be common general knowledge.

The present invention is not to be limited in scope by any of the specific embodiments described herein. These embodiments are intended for the purpose of exemplification only. Functionally equivalent products and methods are clearly within the scope of the invention as described herein.

The invention described herein may include one or more range of values (e.g. size etc). A range of values will be understood to include all values within the range, including the values defining the range, and values adjacent to the range which lead to the same or substantially the same outcome as the values immediately adjacent to that value which defines the boundary to the range.

For the purposes of the present invention the terms “front” and “rear” refer to facing directions relative to the installed position of a door i.e. the rear part of a component such as a door panel is the part of the door panel that faces towards the space inside the opening closed by the door and the front part of a door panel is the part of the door panel that faces towards the space outside the opening.

Throughout this specification, unless the context requires otherwise, the word “comprise” or variations such as “comprises” or “comprising”, will be understood to imply the inclusion of a stated integer or group of integers but not the exclusion of any other integer or group of integers.

Other definitions for selected terms used herein may be found within the detailed description of the invention and apply throughout. Unless otherwise defined, all technical terms used herein have the same meaning as commonly understood to one of ordinary skill in the art to which the invention belongs.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

### DESCRIPTION OF THE PREFERRED EMBODIMENTS

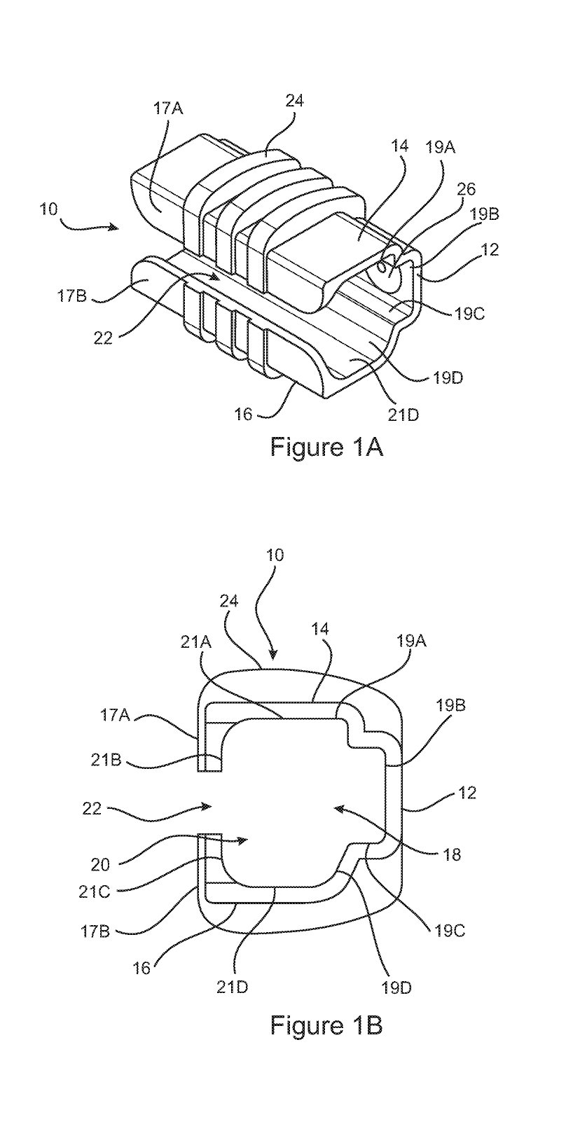

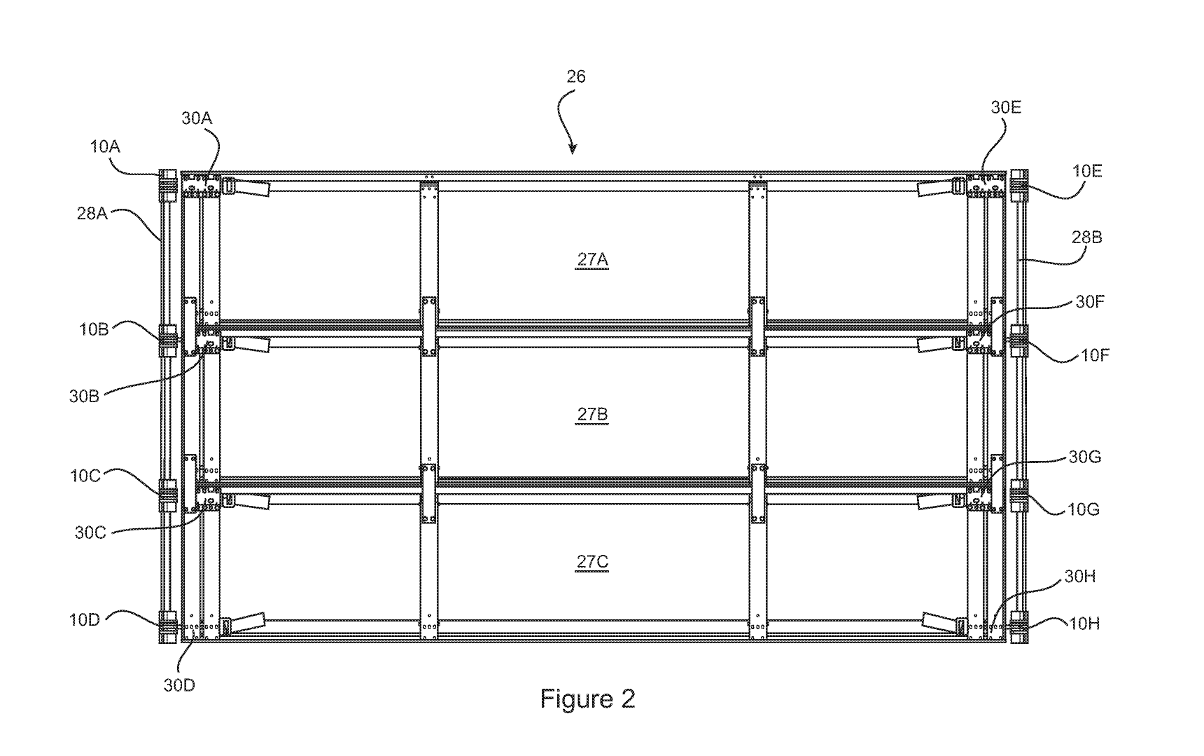

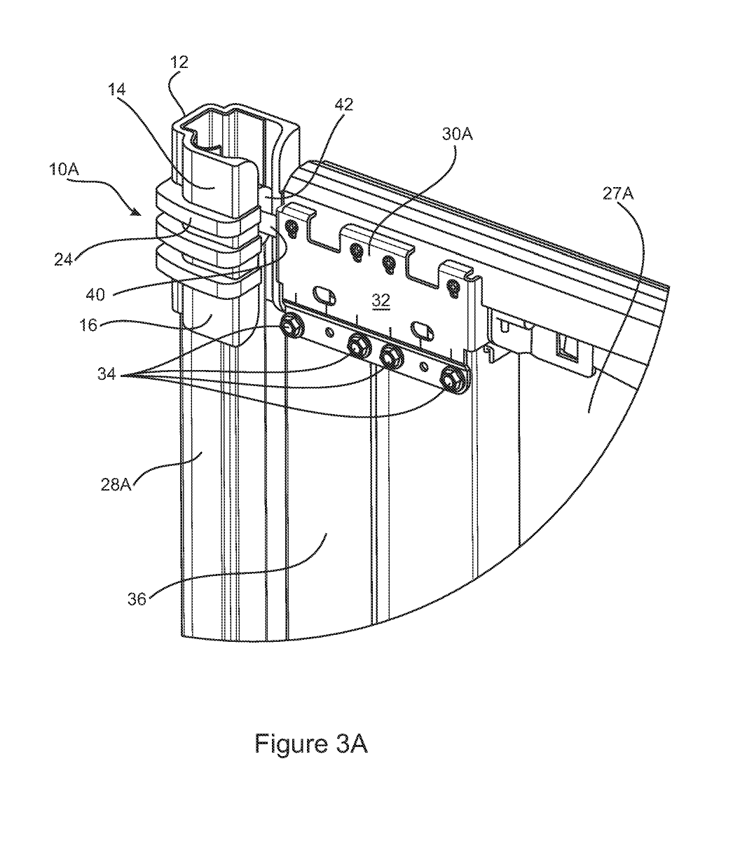

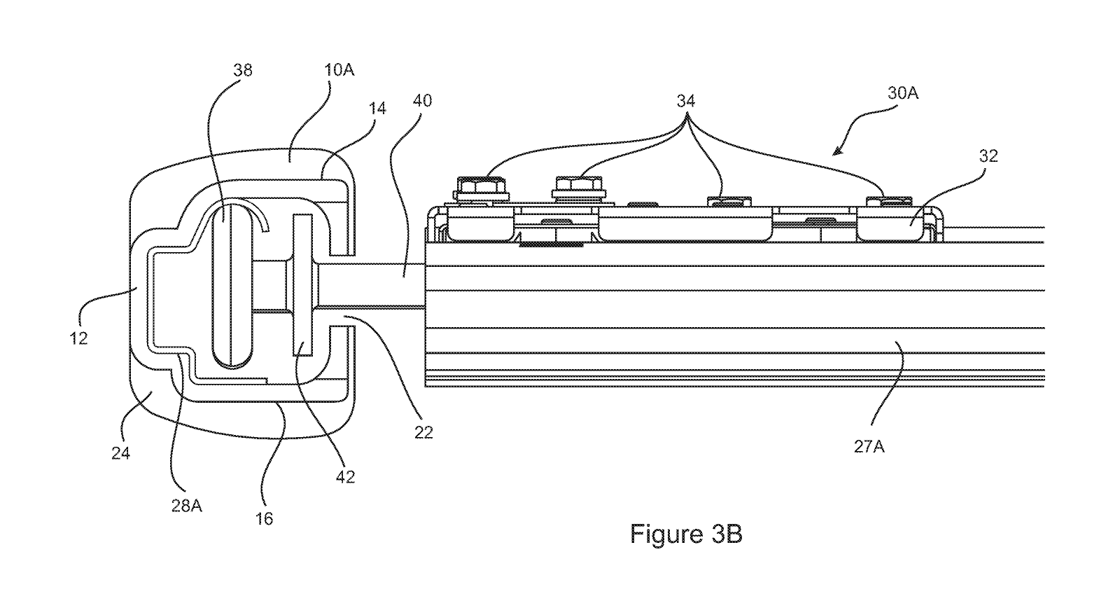

A bracing member according to one embodiment of the first aspect of the present invention is shown in FIGS. 1A and 1B. The bracing member comprises a sleeve member indicated by the numeral 10 with a generally “C”-shaped cross section and is adapted to be mounted to a door guide track (see FIGS. 2 and 3A-3B).

The sleeve member 10 includes a web 12 and two opposed longitudinal sides 14, 16 extending therefrom, that include return sections 17A, 17B, define an interior space or axial passage with a first part 18 with an inner surface that has a profile spanning 19A-19D that matches the external profile of the door guide track and hence is compatible with and adapted to be fitted over a section of the door guide track and a roller member of a roller assembly and a second part 20 adapted to be fitted over an abutment member also formed as part of the roller assembly to reinforce the mount of the sectional door panel to the door guide track. The second part 20 comprises a contact surface spanning 21A-21D for contacting the abutment member when the roller assembly or part thereof is deflected or moved due to forces applied to the door.

The sleeve member 10 also includes a longitudinal opening 22 that extends its entire length and is located opposite the web 12 to allow the passage of the roller assembly therethrough, when in use, without interfering with the normal path of the roller assembly along the door guide track.

The sleeve member 10 also includes a reinforcement member in the form of a series of three lateral ribs 24 that extends around the entire outer surface and towards the middle section of the sleeve member 10. The sleeve member 10 is adapted to be anchored to a structure adjacent to the door guide track such as wall or other fixed object or structure via at least one anchor point in the form of aperture 25 in the web 12 that allows a fixing such as a bolt to be used to anchor the sleeve member 10 to an adjacent structure.

A plurality of the sleeve members 10 in FIGS. 1A and 1B form part of a sectional door system depicted in FIG. 2, according to an embodiment of a third aspect of the present invention. FIG. 2 depicts a sectional door generally indicated by the numeral 26 in the closed or down position from the rear and comprises three hingedly connected panels 27A-27C. Each panel 27A-27C is mounted at its opposed sides in door guide tracks 28A, 28B located adjacent thereto via a pair of couplings according to an embodiment of the second aspect of the invention that each include a roller assembly 30A-30H and a sleeve member 10A-10H. Each of sleeve members 10A-10H can be anchored to a structure (not shown) adjacent thereto.

The couplings in FIG. 2 including sleeve members 10 and the roller assembly 30 are shown in more detail in FIGS. 3A and 3B that show, in detail, the top left portion of the door system in FIG. 2 that includes sleeve member 10A and roller assembly 30A. The coupling in FIGS. 3A and 3B is exemplary of all couplings in FIG. 2.

Roller assembly 30A is mounted at one of its ends to the uppermost panel 27A of sectional door 26 via a bracket 32 that is attached via a series of bolts 34 to a vertical support in the form of stile 36 that spans panel 27A. The other end of the roller assembly 30A comprises a roller member in the form of roller 38 that is located in door guide track 28A and is mounted on a shaft 40. The shaft 40 also includes an abutment member in the form of disk 42 mounted on the shaft 40 and located between the roller 38 and the panel 27A.

Sleeve member 10A is mounted on the door guide track 28A and includes all of the features included in the sleeve member depicted in FIGS. 1A and 1B. In use, the sleeve member 10A and the roller member 30A co-operate to increase the strength of the mount between the sectional door 26 and the door guide track 28A and/or the adjacent structure. In this regard, sleeve member 10A fits around door guide track 28A to at least limit its deformation thereby increasing the amount of force required to remove the roller 38 from the door guide 28A. Sleeve member 10A also captures and surrounds disk 42 thereby increasing the amount of force required to detach the roller assembly 30A from the door guide 28A. Thus, it will be appreciated that the coupling comprising the sleeve member 10A and the roller assembly 30A serves to strengthen the mount between the sectional door 26 and door guide 28A and/or the adjacent structure.

The sleeve member 10 also includes a longitudinal opening 22 that extends its entire length and is located opposite the web 12 to allow the passage of the roller assembly therethrough, when in use, without interfering with the normal path of the roller assembly along the door guide track.

The sleeve member 10 also includes a reinforcement member in the form of a series of three lateral ribs 24 that extends around the entire outer surface and towards the middle section of the sleeve member 10. The sleeve member 10 is adapted to be anchored to a structure adjacent to the door guide track such as wall or other fixed object or structure via at least one anchor point in the form of aperture 26 in the web 12 that allows a fixing such as a bolt to be used to anchor the sleeve member 10 to an adjacent structure.

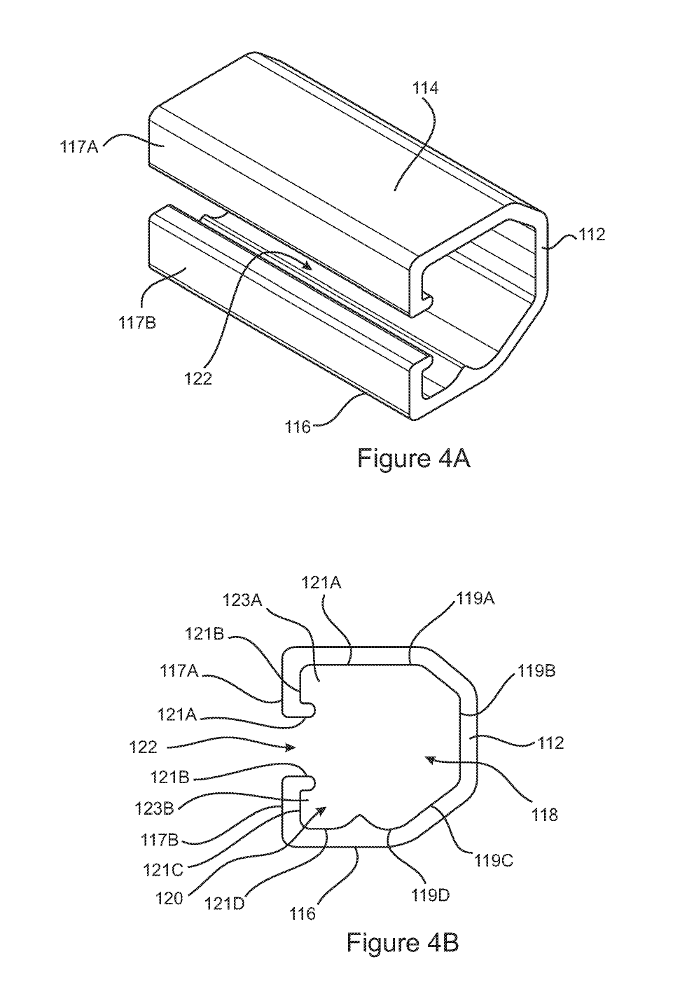

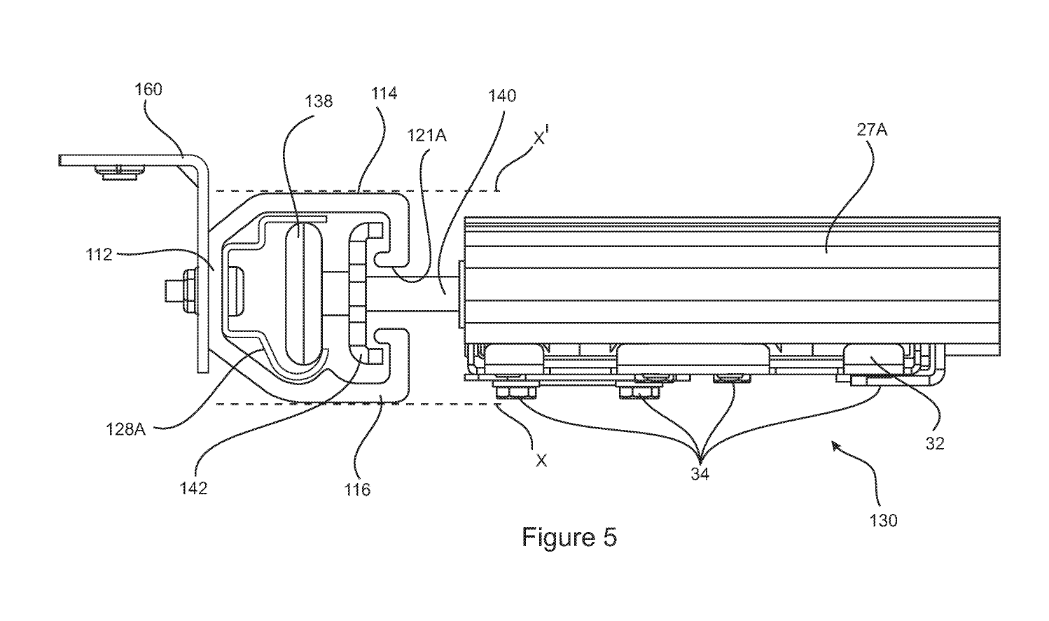

A bracing member according to another embodiment of the first aspect of the present invention is shown in FIGS. 4A and 4B. The bracing member in FIGS. 4A, 4B and 5 can be used instead of or in addition to the bracing member depicted in the earlier figures and comprises a sleeve member indicated by the numeral 110 with a generally “C”-shaped cross section that is adapted to be mounted to a door guide track (see FIG. 5).

The sleeve member 110 includes a web 112 and two opposed longitudinal sides 114, 116 extending therefrom, that include first return sections 117A, 117B and second return sections 121A, 121B. As illustrated in FIG. 5, the first return sections 117A, 117B run perpendicular to a main plane X′, X of the respective opposed longitudinal side walls 114, 116.

The respective second return sections 121A, 121B run parallel to the main plane X′, X of the respective opposed longitudinal side walls 114, 116.

The sleeve member 110 defines an interior space or axial passage with a first part 118 with an inner surface that has a profile spanning 119A-119D that matches part of the external profile of the door guide track and hence is compatible with and adapted to be fitted over a section of the door guide track and a roller member of a roller assembly and a second part 120 adapted to be fitted over an abutment member also formed as part of the roller assembly to reinforce the mount of the sectional door panel to the door guide track. In particular, the second part 120 comprises a channel shaped contact surface spanning 121A-121D that is defined by the first 117A, 117B and second 121A and 121B return sections for contacting the abutment member when the roller assembly 130 or part thereof is deflected or moved due to forces applied to the door.

The sleeve member 110 also includes a longitudinal opening 122 that extends its entire length and is located opposite the web 112 to allow the passage of the roller assembly 130 therethrough, when in use, without interfering with the normal path of the roller assembly 130 along the door guide track.

The sleeve member 110 and the roller assembly 130 are shown in more detail in FIG. 5 that shows, in detail, the top left portion of the door system in FIG. 2, fitted with sleeve member 110 and roller assembly 130. The coupling in FIG. 5 can be used instead of the couplings depicted in FIGS. 2, 3A and 3B.

Roller assembly 130 is mounted at one of its ends to the uppermost panel 27A of sectional door 26 via a bracket 32 that is attached via a series of bolts 34 to a vertical support in the form of stile 36 that spans panel 27A. The other end of the roller assembly 130 comprises a roller member in the form of roller 138 that is located in door guide track 128A and is mounted on a shaft 140. The shaft 140 also includes an abutment member in the form of a U shaped member 142. As shown in FIG. 5, the first 117A, 117B and second 121A and 121B return sections engage with the U shaped member 142 and interlock to stop the bracing member from spreading when under load.

The sleeve member 110 is adapted to be anchored to a structure adjacent to the door guide track such as wall or other fixed object or structure via at least one mounting bracket member 160 that can attach to the structure and to the sleeve member 110 as well as the door guide track 128A.

In use, the sleeve member 110 works in a similar fashion to sleeve member 10 to strengthen the mount between the sectional door 26 and door guide 128A and/or the adjacent structure.

Variations of the embodiments described herein are possible. As an example, the embodiment described with respect to FIGS. 1A, 1 B, 2, 3A, 3B, 4A and 4B can include either first and second return sections or just first return sections.

1-35. (canceled)

36. A bracing member for a door guide track, wherein the door guide track has a body comprising a web and two opposed longitudinal sides extending therefrom to define an interior channel adapted to receive a roller member of a roller assembly that also includes a shaft member and an abutment member, the roller assembly being adapted to mount a sectional door panel to the door guide track, and the bracing member comprising a sleeve member that defines an interior space and an inner surface and is adapted to be fitted over at least a section of the door guide track and the roller member to reinforce the mount of the sectional door panel to the door guide track, wherein the sleeve member comprises a web and two opposed longitudinal side walls joined by the web and each of the opposed longitudinal side walls comprise a first return section and a second return section adapted to engage with the abutment member.

37. A bracing member according to claim 36, wherein the first return section runs perpendicular to a main plane of the respective opposed longitudinal side walls.

38. A bracing member according to claim 37, wherein the second return section runs parallel to the main plane of the respective opposed longitudinal side walls.

39. A bracing member according to claim 36, wherein the interior space includes a first part adapted to retain, capture and/or abut said section of the door guide track and the roller assembly and a second part adapted to retain, capture and/or abut the abutment member.

40. A bracing member according to claim 39, wherein the second part of the interior space comprises a contact surface for the abutment member and is adapted to contact the abutment member when the roller assembly or part thereof is deflected or moved due to forces applied to the door.

41. A bracing member according to claim 36, wherein the interior space defines an axial passage or pathway along the length of the sleeve member.

42. A bracing member according to claim 36, wherein the sleeve member comprises a longitudinal opening located opposite the web and is adapted to receive and allow the passage of the shaft member of the roller assembly therethrough.

43. A bracing member according to claim 42, wherein the longitudinal opening extends the entire length of the sleeve member.

44. A bracing member according to claim 36, wherein the sleeve member has a generally “U” shaped outer cross section.

45. A bracing member according to claim 36, wherein the sleeve member has a generally “C” shaped outer cross section.

46. A bracing member according to claim 36, wherein the inner surface comprises a profile that is shaped to fit around at least part of the outer profile of the door track guide body.

47. A bracing member according to claim 46, wherein the inner surface comprises a profile that is shaped to fit around part of the outer profile of the two opposed longitudinal sides of the door track guide body.

48. A bracing member according to claim 46, wherein the fit between the inner surface of the sleeve member and the door track guide body is a flush fit, interference fit, or a friction fit.

49. A bracing member according to claim 36, wherein the sleeve member is adapted to slidingly fit on the door track guide body.

50. A bracing member according to claim 36, wherein the sleeve member further comprises a reinforcement member adapted to prevent, control or otherwise limit the deflection of the sleeve member.

51. A bracing member according to claim 36, wherein the abutment member comprises a disk shaped body.

52. A bracing member according to claim 36, wherein the abutment member comprises a body with a “U” shaped cross section.

53. A bracing member according to claim 36, wherein the abutment member is fixedly mounted on the shaft member.

54. A bracing member for a door guide track, wherein the door guide track has a body comprising a web and two opposed longitudinal sides extending therefrom to define an interior channel adapted to receive a roller member of a roller assembly that also includes a shaft member and is adapted to mount a sectional door panel to the door guide track, the bracing member comprising: a sleeve member that defines an interior space and an inner surface and is adapted to be fitted over at least a section of the door guide track and the roller member to reinforce the mount of the sectional door panel to the door guide track without interfering with the normal path of the roller assembly along the door guide track.

55. A bracing member for a door guide track, wherein the door guide track has a body comprising a web and two opposed longitudinal sides extending therefrom to define an interior channel adapted to receive a roller member of a roller assembly that also includes a shaft member and an abutment member, the roller assembly being adapted to mount a sectional door panel to the door guide track, the bracing member comprising: a sleeve member that defines an interior space and an inner surface and is adapted to be fitted over at least a section of the door guide track and the roller member to reinforce the mount of the sectional door panel to the door guide track without interfering with the normal path of the roller assembly along the door guide track, wherein the interior space includes a first part adapted to retain, capture and/or abut said section of the door guide track and the roller assembly and a second part adapted to retain, capture and/or abut an abutment member.
